(19) United States
(12) Patent Application Publication
(10) Pub. No.: US 2020/0044468 A1
(43) Pub. Date: Feb. 6, 2020

(54) MOBILE POWER SUPPLY MODULE WITH LIGHT SOURCE

(71) Applicant: Ling Yung LIN, Taipei (TW)

(72) Inventor: Ling Yung LIN, Taipei (TW)

(21) Appl. No.: 16/050,648

(22) Filed: Jul. 31, 2018

(51) Int. Cl. H02J 7/00; H05B 37/02; H02J 50/80; H02J 50/10; H02J 7/02; H02J 50/40

(52) U.S. Cl. CPC H02J 7/0047; H02J 7/0052; H05B 37/02; H02J 50/40; H02J 7/0044; H02J 50/10; H02J 7/025; H02J 50/80

(57) ABSTRACT

A mobile power supply module with a light source includes a power supply device and at least one power bank. The power supply device generates an electromagnetic field area and underpins the power bank. The power bank receives electromagnetic waves from the electromagnetic field area and converts the electromagnetic waves into electric power for storage. The power bank has a light-emitting unit for emitting light and an output port for supplying power, to function as a mobile power supply source, provide illumination and effectuate decoration, as needed, so as to enhance comfort and convenience of a living environment.

### BACKGROUND OF THE INVENTION

### 1. Technical Field

The present disclosure relates to mobile power and, more particularly, to a mobile power supply module capable of being wirelessly charged conveniently and capable of functioning as a mobile lamp.

### 2. Description of Related Art

Owing to technological advancement, use of electric appliances is closely intertwined with daily life. Various convenient mobile 3C electronic products and various compact home appliance products are integrated into daily life. However, power storage capacity of electronic products, such as smartphones and tablets, is so limited that the electronic products are incapable of long continuous use. Furthermore, to use the electronic products indoors, numerous users usually electrically connect the electronic products to electrical outlets and thus are confined thereto. As a result, the use of the electronic products is subject to the positions of the electrical outlets and surroundings. If the surroundings are unsatisfactory (for example, inadequate illumination), the users will have to tolerate the surroundings at the expense of comfort and convenience. Moreover, although an extension cord frees the users from the reach limitation of the electrical outlets, it brings inconvenience to a living environment.

### BRIEF SUMMARY OF THE INVENTION

In view of the aforesaid drawbacks of the prior art, it is an objective of the present disclosure to provide illumination jointly by wireless charging, a mobile power supply source and a power supply source, so as to form a convenient mobile power supply source capable of illumination and lighting decoration, overcome known drawbacks, and enhance comfort and convenience in a living environment.

The present disclosure provides a mobile power supply module with a light source, using a power supply device to generate an electromagnetic field and charge at least one power bank. The power bank in operation is movable and thereby serves as a power supply source which is not stationary. The mobile power supply module supplies power and effectuates illumination as needed. The mobile power supply module not only features enhanced ease of use, but also improves the living environment and quality by supplying power without using any extension cord.

In order to achieve the above and other objectives, the present disclosure provides a mobile power supply module with a light source, comprising a power supply device and at least one power bank. The power supply device comprises a substantially flat carrying surface and an electromagnetic field generating unit disposed below the carrying surface. The carrying surface is adapted to carry the power bank. The electromagnetic field generating unit generates an electromagnetic field area on the carrying surface when powered. The power bank comprises an electromagnetic receiving unit and a power storage unit. When the power bank is located within the electromagnetic field area, the electromagnetic receiving unit receives and converts electromagnetic waves into electric power to be stored in the power storage unit. The power bank further comprises a light-emitting unit for emitting light and an output port for outputting power. The light-emitting unit and the output port are each electrically connected to the power storage unit.

Preferably, a conversion circuit is disposed between the electromagnetic receiving unit and the power storage unit and adapted to convert electromagnetic waves into electric power.

Preferably, the power bank has a processing unit. The processing unit connects to the power storage unit, the light-emitting unit and the output port, allowing the light-emitting unit to turn on/off or the output port to output power under the processing unit's control.

Preferably, the power bank has a control switch connected to the processing unit.

Preferably, the power bank has a signal receiving unit connected to the processing unit and adapted to receive a remote control signal.

Preferably, the power supply device is adapted to carry a plurality of power banks such that the power banks receive electromagnetic waves within the electromagnetic field area.

Preferably, the power bank has a casing, and the casing comprises a light-penetrable portion to be capable of light emitting out casing.

Preferably, the power bank is coupled to a lampshade.

Preferably, a first engaging portion is disposed on an outer side of the casing of the power bank, and the lampshade comprises a second engaging portion engaged with the first engaging portion.

Objectives, features, and advantages of the present disclosure are hereunder illustrated with specific embodiments, depicted by the accompanying drawings, and described in detail below.

### BRIEF DESCRIPTION OF THE SEVERAL VIEWS OF THE DRAWINGS

FIG. 1 is a perspective view of a mobile power supply module with a light source according to a preferred embodiment of the present disclosure;

FIG. 2 is an exploded view of a power supply device of the mobile power supply module;

FIG. 3 is an exploded view of a power bank of the mobile power supply module;

FIG. 4 is a schematic view of wireless power supply;

FIG. 5 is a schematic view of the interior of the power bank;

FIG. 6 is a schematic view of how to connect the power bank to a pathway seat; and

FIG. 7 is a schematic view of the power bank mounted in a lampshade.

### DETAILED DESCRIPTION OF THE INVENTION

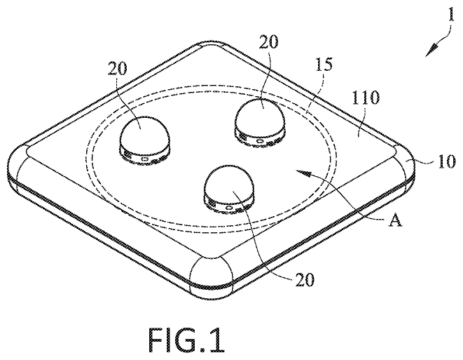

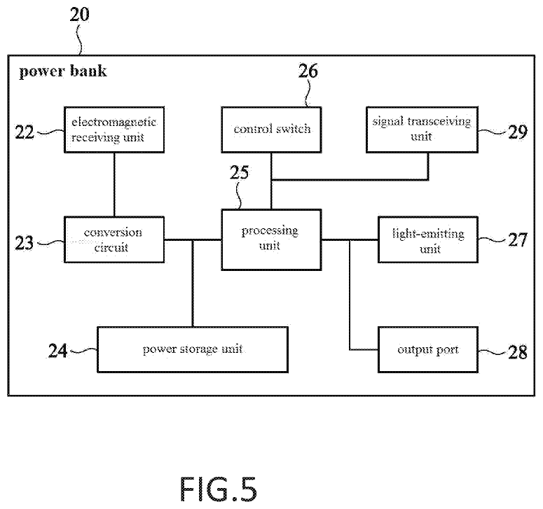

Referring to FIG. 1 through FIG. 5, the mobile power supply module 1 of the present disclosure essentially comprises a power supply device 10 and a plurality of power banks 20.

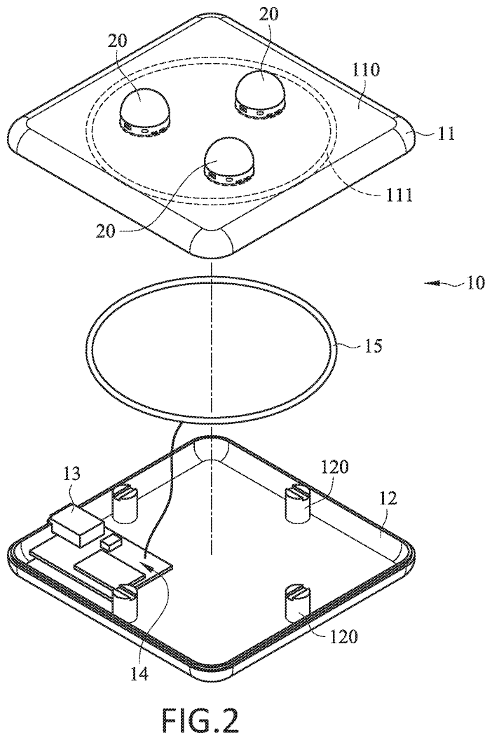

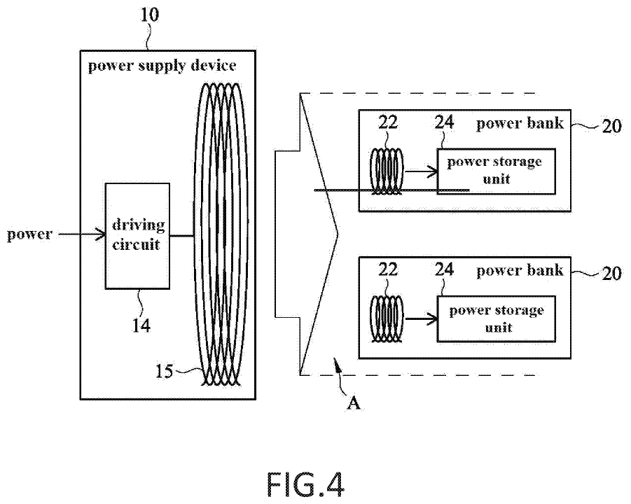

The power supply device 10, as shown in FIG. 2 and FIG. 4, comprises an upper housing 11 and a lower housing 12 and is a six-sided polygon. The power supply device 10 contains a driving circuit 14 and an electromagnetic field generating unit 15. The driving circuit 14 is electrically connected to the electromagnetic field generating unit 15 and connected to a power jack 13. A power supply plug is inserted into the power jack 13 so that power is supplied to the electromagnetic field generating unit 15 through the driving circuit 14, so as to generate an electromagnetic field. A carrying surface 110 is defined on the outer surface of the upper housing 11. At least one power bank 20 is placed on the carrying surface 110. An annular groove 111 is disposed on the inner side of the upper housing 11. The electromagnetic field generating unit 15 is positioned in place by the annular groove 111. The lower housing 12 has a plurality of posts 120 for abutting against the electromagnetic field generating unit 15 to allow the electromagnetic field generating unit 15 to be firmly fixed to the groove 111 and disposed below the carrying surface 110. Therefore, when powered, the electromagnetic field generating unit 15 generates an electromagnetic field area A within a corresponding area on the carrying surface 110.

In a practicable embodiment, the power supply device 10 is a wireless charger. The power jack 13 uses a Micro USB as a power input port for receiving DC power. The driving circuit 14 is an MOS driving circuit. The electromagnetic field generating unit 15 is a magnetic field coil capable of producing magnetic field effect. The MOS driving circuit generates and supplies continuous pulse power to the magnetic field coil for producing a magnetic field. The above-mentioned is a technique conducive to power saving, prevention of high temperature, and enhancement of magnetic field effect.

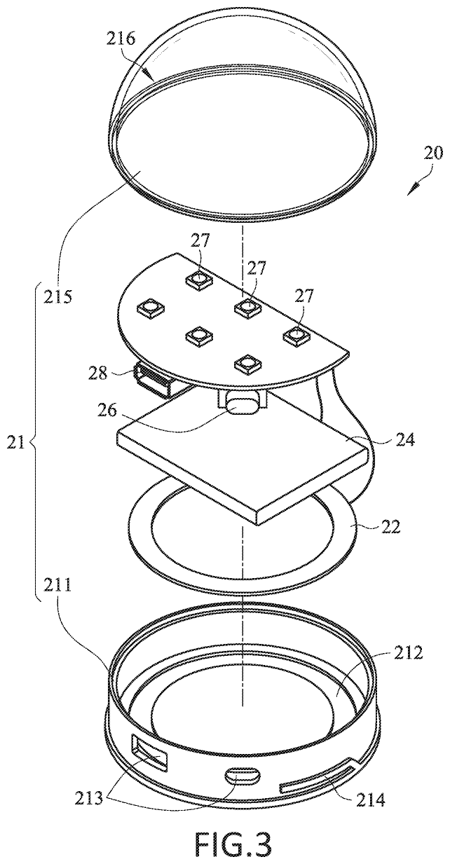

The power bank 20, as shown in FIG. 3 through FIG. 5, has a casing 21 and electrically-connected components contained in the casing 21. The components include an electromagnetic receiving unit 22, a power storage unit 24 and a circuit board which are electrically connected to each other. The circuit board comprises a conversion circuit 23, a processing unit 25, a signal receiving unit 29 and light-emitting units 27 disposed on the circuit board. The circuit board is electrically connected to a control switch 26 and an output port 28.

The casing 21 of the power bank 20 comprises a base 211 and a cover 215. An annular groove 212 is concavely disposed on the inner bottom surface of the base 211. The electromagnetic receiving unit 22 is positioned in place by the annular groove 212. Both the power storage unit 24 and the circuit board press against the electromagnetic receiving unit 22 from above such that the electromagnetic receiving unit 22 is firmly fixed in the groove 212. The cover 215 comprises a light-penetrable portion 216 which is transparent or translucent; hence, light emitted from the light-emitting unit 27 controlled to effectuate light emission can propagate outward. The base 211 has openings 213 corresponding in position to the control switch 26 and the output port 28, respectively. Therefore, the output port 28 is connected to an electronic device to be powered, whereas the control switch 26 is operated by users.

In a practicable embodiment, the electromagnetic receiving unit 22 is a magnetic field coil for receiving electromagnetic waves from the electromagnetic field, and then the electromagnetic waves are converted into electric power by the conversion circuit 23 such that the electric power is stored in the power storage unit 24. The processing unit 25 is a microprocessor which connects to and control electronic components in the power bank 20, so as to control power output of the power storage unit 24, light emission mode of the light-emitting unit 27, and power output of the output port 28 according to a received control signal (a signal from the control switch 26 or a remote control signal of the signal receiving unit 29). The light-emitting unit 27 is a multi-color LED controllable to emit light for use in illumination or for use by a decoration-oriented device (the power bank 20 further functions as a decorative lamp.) The output port 28 is a USB for supplying power and inputting a signal.

To be charged, the power bank 20 is placed on the carrying surface 110 of the power supply device 10 and positioned within the electromagnetic field area A. At this point in time, the electromagnetic receiving unit 22 within the electromagnetic field area A receives electromagnetic waves spontaneously. The electromagnetic waves thus received is converted into electric power by the conversion circuit 23. Finally, the electric power is stored in the power storage unit 24, thereby finalizing the charging process. To be accessible, the power bank 20 is moved and placed at an expected position such that it can be connected to an intended electronic device. Then, the users operate the control switch 26 to switch to a power output mode preconfigured in the processing unit 25, so as to control the power output of the power storage unit 24, start the illumination and decoration of the light-emitting unit 27, and enable the output port 28 to supply power to the electronic device.

In a practicable embodiment, the power supply device 10 is of a larger size than the power bank 20 to underpin the power banks 20 and be charged simultaneously. The users may switch between the power banks 20 conveniently. The power banks 20 are disk-shaped objects which are, for example, cylindrical, cubic or geometrically-shaped, spherical objects, and conical objects.

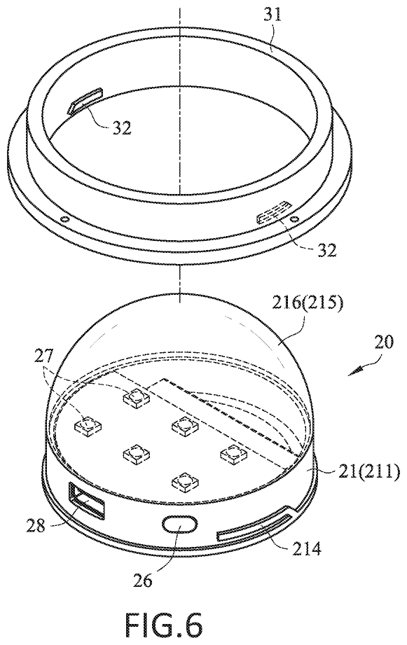

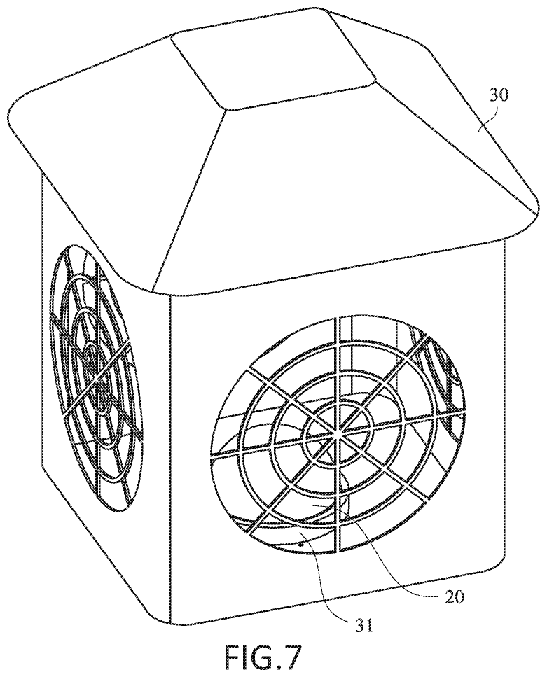

Referring to FIG. 6 and FIG. 7, in this embodiment, the power bank 20 is further coupled to a lampshade 30 to provide esthetic illumination and effectual decoration. The lampshade 30 has an annular pathway seat 31. A second engaging portion 32 is disposed on the inner side of the pathway seat 31. A first engaging portion 214 is disposed at the power bank 20 and corresponds in position to the second engaging portion 32. Coupling the first engaging portion 214 and the second engaging portion 32 together allows the power bank 20 to be mounted in the lampshade 30. In this embodiment, the first engaging portion 214 is a slot, whereas the second engaging portion 32 is a latch. However, in a practicable embodiment, the first engaging portion 214 is a latch, whereas the second engaging portion 32 is a slot. The quantity, positions and shapes of the control switch 26, output port 28, first engaging portion 214 and second engaging portion 32 are subject to changes as needed and thus are not restricted to what are shown in the diagrams in this embodiment.

In conclusion, a mobile power supply module with a light source according to the present disclosure provides a convenient mobile power supply source, wireless environments, illumination, and beauty, so as to enhance environmental quality, achieve industrial applicability, and provide comfort to users. The present disclosure is disclosed above by preferred embodiments. However, persons skilled in the art should understand that the preferred embodiments are illustrative of the present disclosure only, and thus variations, modifications, changes and equivalent replacements made to the aforesaid embodiments in accordance with the scope and technical measures of the present disclosure shall fall within the claims of the present disclosure.

What is claimed is:

1. A mobile power supply module with a light source, comprising:
a power supply device comprising a substantially flat carrying surface and an electromagnetic field generating unit disposed below the carrying surface, the carrying surface adapted to carry at least one power bank, and the electromagnetic field generating unit generating an electromagnetic field area on the carrying surface when powered;
wherein the power bank comprises an electromagnetic receiving unit and a power storage unit such that, when the power bank is located within the electromagnetic field area, the electromagnetic receiving unit receives and converts electromagnetic waves into electric power to be stored in the power storage unit;
wherein the power bank further comprises a light-emitting unit for emitting light and an output port for outputting power, wherein the light-emitting unit and the output port are each electrically connected to the power storage unit.

2. The mobile power supply module of claim 1, wherein a conversion circuit is disposed between the electromagnetic receiving unit and the power storage unit and adapted to convert electromagnetic waves into electric power.

3. The mobile power supply module of claim 1, wherein the power bank has a processing unit, and the processing unit connects to the power storage unit, the light-emitting unit and the output port, allowing the light-emitting unit to turn on or turn off or the output port to output power under the processing unit's control.

4. The mobile power supply module of claim 3, wherein the power bank has a control switch connected to the processing unit.

5. The mobile power supply module of claim 3, wherein the power bank has a signal receiving unit connected to the processing unit and adapted to receive a remote control signal.

6. The mobile power supply module of claim 1, wherein the power supply device is adapted to carry a plurality of power banks such that the power banks receive electromagnetic waves within the electromagnetic field area.

7. The mobile power supply module of claim 1, wherein the power bank has a casing, and the casing comprises a light-penetrable portion to be capable of light emitting out casing.

8. The mobile power supply module of claim 7, wherein the power bank is coupled to a lampshade.

9. The mobile power supply module of claim 8, wherein a first engaging portion is disposed on an outer side of the casing of the power bank, and the lampshade comprises a second engaging portion engaged with the first engaging portion.
